(19) United States
(12) Patent Application Publication
(10) Pub. No.: US 2024/0319538 A1
(43) Pub. Date: Sep. 26, 2024

(54) DISPLAY DEVICE

(71) Applicant: Funai Electric Co., Ltd., Osaka (JP)

(72) Inventor: Yuki ISHIZUKA, Osaka (JP)

(21) Appl. No.: 18/583,174

(22) Filed: Feb. 21, 2024

(30) Foreign Application Priority Data
Mar. 20, 2023 (JP) 2023-044705

(51) Int. Cl. G02F 1/1335; G02F 1/1333; G02F 1/13357; G02F 1/1339

(52) U.S. Cl. CPC G02F 1/133607; G02F 1/133314; G02F 1/133605; G02F 1/1339

(57) ABSTRACT

A display device comprises a display panel, a backlight unit, and a rear frame. The backlight unit includes a light source unit that emits light and a sheet-like optical member that diffuses the light from the light source unit toward a rear surface of the display panel. The rear frame covers the backlight unit from a rear side of the display device. The light source unit has a first light source that is disposed spaced apart from the optical member in a front-rear direction of the display device and is provided with a first lens, and a second light source that is disposed spaced apart from the optical member and closer to the optical member than the first light source in the front-rear direction and is provided with a second lens. The first lens and the second lens have different light distribution characteristics from each other.

### CROSS-REFERENCE TO RELATED APPLICATIONS

This application claims priority to Japanese Patent Application No. 2023-44705 filed in Japan on Mar. 20, 2023. The entire disclosure of Japanese Patent Application No. 2023-44705 is hereby incorporated herein by reference.

### BACKGROUND

### Field of the Invention

This invention generally relates to a display device. More specifically, this invention relates to a display device with a backlight unit.

### Background Information

Conventionally, a display device equipped with a backlight unit is known (see Japanese Laid-Open Patent Application Publication No. 2016-021061 (Patent Literature 1), for example).

The above-mentioned Patent Literature 1 discloses a television receiver (display device) having a display panel with a display surface, a backlight unit irradiating light from the rear of the display panel to the display panel, and a rear frame located at the rear of the backlight unit. With this television receiver, the backlight unit includes a plurality of light sources that are spaced apart from the display panel by an approximate uniform distance, respectively, and are fixed to a front surface of the rear frame. With this television receiver, a main circuit board that controls the display panel and the backlight unit is located at the rear of the rear frame. The entire rear surface of the main circuit board is covered by a rear cover, which forms a housing of the television receiver.

### SUMMARY

However, in the television receiver (display device) equipped with the backlight unit described in the above-mentioned Patent Literature 1, the main circuit board that controls the display panel and the backlight unit is located at the rear of the rear frame where the light sources are fixed at the front surface, and the entire rear surface of the rear frame where the main circuit board is placed is covered by the rear cover, which forms a housing of the television receiver. Therefore, there is a problem that the thickness of the television receiver (display device) in the front-rear direction increases to the extent that the main circuit board is placed at the rear of the rear frame.

One object of this disclosure is to provide a display device capable of suppressing an increase in the thickness in the front-rear direction.

In view of the state of the known technology, a display device according to an aspect of this disclosure comprises a display panel with a display surface, a backlight unit, and a rear frame. The backlight unit is configured to irradiate light to the display panel from a rear side of the display panel. The backlight unit includes a light source unit that is configured to emit light and a sheet-like optical member that is configured to diffuse the light from the light source unit toward a rear surface of the display panel. The rear frame covers the backlight unit from a rear side of the display device. The light source unit has a first light source that is disposed spaced apart from the optical member in a front-rear direction of the display device and is provided with a first lens, and a second light source that is disposed spaced apart from the optical member and closer to the optical member than the first light source in the front-rear direction and is provided with a second lens. The first lens and the second lens have different light distribution characteristics from each other.

### BRIEF DESCRIPTION OF THE DRAWINGS

FIG. 1 is an overall front perspective view of a display device according to a first embodiment.

FIG. 2 is a partial exploded view of the display device according to the first embodiment.

FIG. 3 is a schematic longitudinal cross-sectional view of the display device showing the positional relationship between a light source unit and an optical member according to the first embodiment.

FIG. 4 is a perspective view of a reflective sheet according to the first embodiment.

FIG. 5 is a diagram showing the configuration of a first light source portion according to the first embodiment.

FIG. 6 is a diagram showing the configuration of a second light source portion according to the first embodiment.

FIG. 7 is a diagram illustrating the light distribution characteristics of a first lens and a second lens according to the first embodiment.

FIG. 8 is a graph illustrating the light distribution characteristics of the first lens and the second lens according to the first embodiment.

FIG. 9 is a front view illustrating a light reflection suppressing portion according to the first embodiment.

FIG. 10 is a front view illustrating a variation of the light reflection suppressing portion according to the first embodiment.

FIG. 11 is a perspective view of a reflective sheet with a light reflection suppressing portion according to the first embodiment.

FIG. 12 is a perspective view showing the light source unit, panel posts and a rear frame according to the first embodiment.

FIG. 13 is a schematic longitudinal cross-sectional view of a display device according to a second embodiment, showing the positional relationship between a light source unit and an optical member.

FIG. 14 is a schematic longitudinal cross-sectional view of a display device according to a third embodiment, showing the positional relationship between a light source unit and an optical member.

FIG. 15 is a schematic longitudinal cross-sectional view of a display device according to a fourth embodiment, showing the positional relationship between a light source unit and an optical member.

FIG. 16 is a schematic longitudinal cross-sectional view of a display device according to a fifth embodiment, showing the positional relationship between a light source unit and an optical member.

FIG. 17 is a schematic longitudinal cross-sectional view of a display device according to a sixth embodiment, showing the positional relationship between a light source unit and an optical member.

FIG. 18 is a longitudinal cross-sectional view showing the configuration of a reflective lens according to a first modification.

FIG. 19 is a perspective view illustrating the shape of a light source unit according to a second modification.

FIG. 20 is a perspective view illustrating the shape of a light source unit according to a third modification.

FIG. 21 is a perspective view illustrating the configuration of a reflective member according to a fourth modification.

FIG. 22 is a perspective view illustrating the configuration of a reflective member according to a fifth modification.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

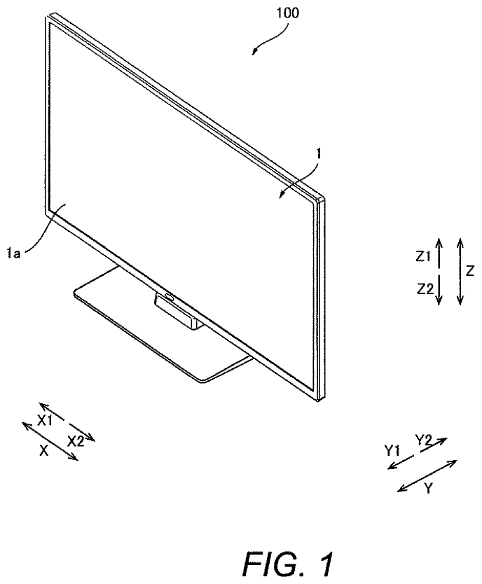

A display device 100 of a first embodiment of the disclosure will be described below with reference to FIGS. 1 to 12.

### (Configuration of Display Device)

The display device 100 is configured to display images and video on a front surface of a display panel 1. The display device 100 has the display panel 1, a backlight unit 2, a rear frame 3, a component part 4, and a rear cover 5, as shown in FIGS. 1 to 3.

### (Configuration of Display Panel)

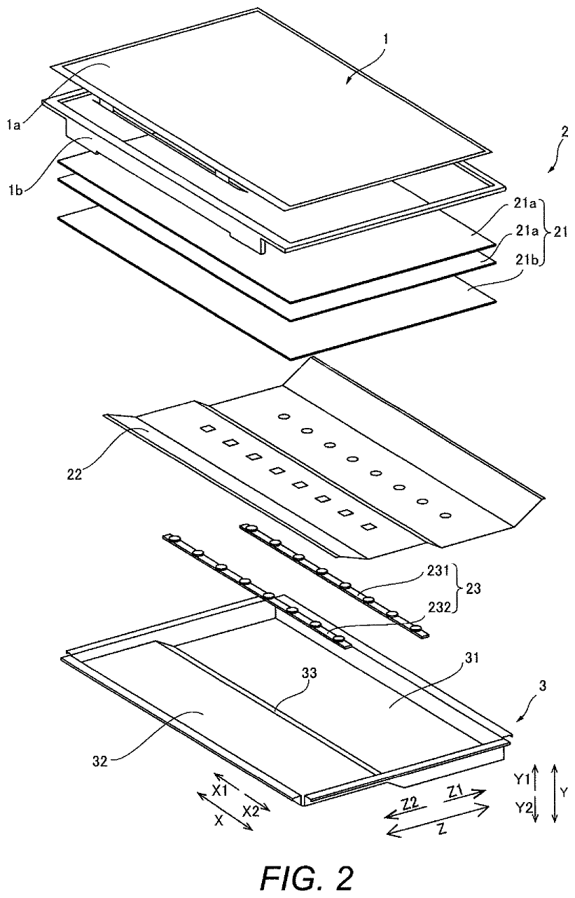

First, the configuration of the display panel 1 will be described with reference to FIGS. 1 and 2. The display panel 1 includes a display surface 1a. The display panel 1 is a liquid crystal display panel. The display panel 1 is configured to display an image on the display surface 1a by changing the transmittance of the liquid crystal in response to light irradiated from the backlight unit 2. In the illustrated embodiment, the left-right direction (i.e., the horizontal direction) of the display device 100 is also referred to as an X direction, and the front-rear direction (thickness) of the display device 100 is also referred to as a Y direction. The up-down direction (i.e., the vertical direction) of the display device 100 is also referred to as a Z direction. The display surface 1a is disposed on the front side (Y1 direction side) of the display panel 1 and has a rectangular flat plate shape. A cell guide 1b is disposed on the rear side (Y2 direction side) of the display panel 1. The cell guide 1b supports the display panel 1 from the rear side (Y2 direction side). The cell guide 1b is formed in a frame-like rectangular shape that circumferentially surrounds the display panel 1.

### (Configuration of Backlight Unit)

Next, the configuration of the backlight unit 2 is explained with reference to FIG. 2. The backlight unit 2 irradiates light onto the display panel 1 from the rear side of the display panel 1. The backlight unit 2 includes an optical member (e.g., a sheet-like optical member) 21, a reflective sheet 22, and a light source unit 23. The reflective sheet 22 is an example of a “sheet-like reflective member” of the present disclosure.

### (Configuration of Optical Member)

The optical member 21 has a plurality of optical sheets 21a and a diffusion plate 21b. The optical member 21 is configured to guide the light irradiated from the light source unit 23 to the entire rear surface of the display panel 1. The optical sheets 21a irradiate the light to the display panel 1 by adjusting the direction of polarization of the light and suppressing diffusion of the light. The diffusion plate 21b is configured to diffuse the light from the light source unit 23. The optical member 21 is positioned between the display panel 1 and the reflective sheet 22 in the front-rear direction (Y direction) of the display device 100. The optical sheets 21a and the diffusion plate 21b are stacked in this order from the display panel 1 side (Y1 direction side) to the rear frame 3 side (Y2 direction side). The optical member 21 is formed in a rectangular flat plate shape as viewed in the front-rear direction (Y direction) of the display device 100. In the illustrated embodiment, the optical member 21 has a pair of optical sheets 21a, but the number of the optical sheets 21a is not limited to this. The optical member 21 can have only one optical sheet 21a or three or more optical sheets 21a, as needed and desired.

### (Configuration of Reflective Sheet)

Referring now to FIG. 4, the configuration of the reflective sheet 22 will be described. The reflective sheet 22 includes a first reflective surface 221, a second reflective surface 222, a connecting surface 223, a pair of end inclined surfaces 224a and 224b, and a plurality of openings 221a and 222a. The reflective sheet 22 reflects the light from the light source unit 23 toward the display panel 1. The reflective sheet 22 is disposed between the optical member 21 and the rear frame 3 in the front-rear direction (Y direction) of the display device 100.

All of the surfaces forming the reflective sheet 22 (i.e., the first reflective surface 221, the second reflective surface 222, the connecting surface 223, and the end inclined surfaces 224a and 224b) are integrally formed. Thus, the reflective sheet 22 is integrally formed as a one-piece, unitary member. Each of the surfaces forming the reflective sheet 22 has a rectangular flat shape. The reflective sheet 22 has an approximately plate shape and has two surfaces (i.e., the first reflective surface 221 and the second reflective surface 222) with different optical distances to the optical member 21, which are the distances between the optical member 21 and the light source unit 23. The connecting surface 223 forms a boundary between the first reflective surface 221 and the second reflective surface 222, and is connected between one side of the first reflective surface 221 extending in the left-right direction (X direction) and one side of the second reflective surface 222 extending in the left-right direction (X direction) on the Y direction side. The end inclined surfaces 224a and 224b are connected to one sides of the first reflective surface 221 and the second reflective surface 222 that extend in the left-right direction (X-direction) on the Y direction side in an inclined manner, respectively. The end inclined surface 224a slopes from the connection with the first reflective surface 221 to the upper direction (Z1 direction side) in the display device 100, and the end inclined surface 224b slopes from the connection with the second reflective surface 222 to the lower direction (Z2 direction side) in the display device 100.

The first reflective surface 221 has the openings 221a in which a first light source portion (e.g., a first light source) 231 of the light source unit 23 is disposed. The second reflective surface 222 has the openings 222a in which a second light source portion (e.g., a second light source) 232 of the light source unit 23 is disposed. The openings 221a are arranged on the first reflective surface 221 along the left-right direction (X direction) of the display device 100. The openings 221b are arranged on the second reflective surface 222 along the left-right direction (X direction) of the display device 100.

### (Configuration of Light Source Unit)

The light source unit 23 is located on the rear side of the display panel 1. In other words, the backlight unit 2 is a direct-lit backlight. The light source unit 23 has the first light source portion 231 and the second light source portion 232. The first light source portion 231 and the second light source portion 232 of the light source unit 23 emit light, respectively. The first light source portion 231 includes a plurality of first lenses 231a, a plurality of light emitting diodes (LEDs) 231b, and a light source board 231c. The second light source portion 232 includes a plurality of second lenses 232a, a plurality of LEDs 232b, and a light source board 232c. The LEDs 231b are an example of a “light emitting element” of the present disclosure. The LEDs 232b are also an example of a “light emitting element” of the present disclosure.

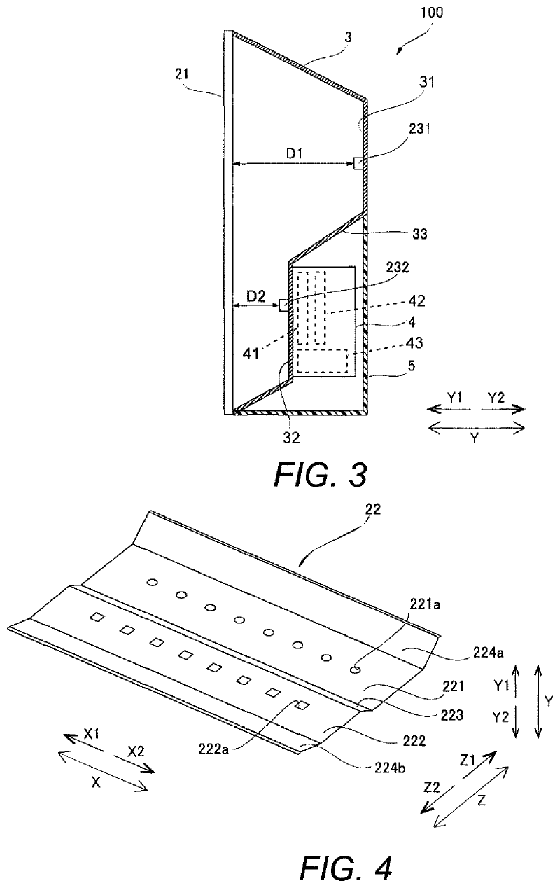

The light source unit 23 is located on the front side (Y1 direction) of the rear frame 3. The first light source portion 231 is arranged so that the LEDs 231b are exposed on the front side through the openings 221a of the reflective sheet 22, respectively. The first light source portion 231 is disposed at a position separated from the optical member 21 by a first distance D1 in the front-rear direction (Y direction), as shown in FIG. 3. In other words, the optical distance of the first light source portion 231, which is the distance between the optical member 21 and the first light source portion 231, is the first distance D1. The first lenses 231a, the LEDs 231b, and the light source board 231c are arranged in this order from the display panel 1 side (Y1 direction side) to the rear frame 3 side (Y2 direction side). In particular, the LEDs 231b are disposed on the light source board 231c such that the LEDs 231b are electrically connected to the light source board 231c, and the first lenses 231a are arranged corresponding to the LEDs 231b, respectively, such that the first lenses 231a cover the LEDs 231b, respectively.

The second light source portion 232 is arranged so that the LEDs 232b are exposed on the front side through the openings 222a of the reflective sheet 22, respectively. The second light source portion 232 is disposed at a position separated from the optical member 21 by a second distance D2 in the front-rear direction (Y-direction), as shown in FIG. 3. In other words, the optical distance of the second light source portion 232, which is the distance between the optical member 21 and the second light source portion 232, is the second distance D2. In the illustrated embodiment, the second distance D2 is smaller than the first distance D1. Thus, in the illustrated embodiment, the second light source portion 232 is disposed closer to the optical member 21 than the first light source portion 231. The second lenses 232a, the LEDs 232b, and the light source board 232c are arranged in this order from the display panel 1 side (Y1 direction side) to the rear frame 3 side (Y2 direction side). In particular, the LEDs 232b are disposed on the light source board 232c such that the LEDs 232b are electrically connected to the light source board 232c, and the second lenses 232a are arranged corresponding to the LEDs 232b, respectively, such that the second lenses 232a cover the LEDs 232b, respectively.

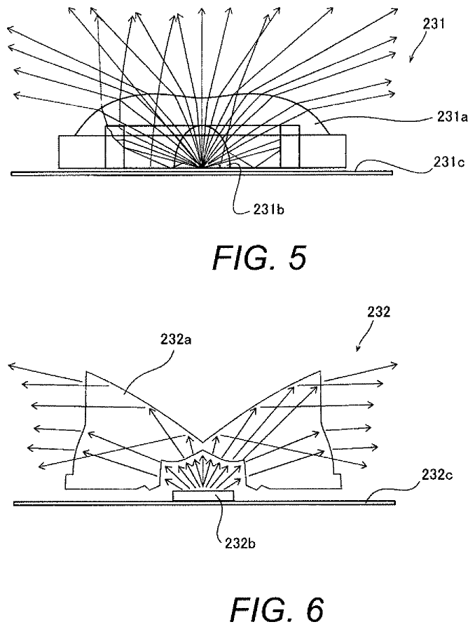

In the illustrated embodiment, the first lenses 231a include refractive lenses, respectively, as shown in FIG. 5. The refractive lenses of the first lenses 231a are formed in a dome shape protruding toward the display panel 1 side (Y1 direction side) and their center parts are depressed toward the rear frame 3 side (Y2 direction side).

The second lenses 232a are configured to diffuse light more than the first lenses 231a. Specifically, the second lenses 232a include reflective/refractive lenses, respectively, as shown in FIG. 6. The reflective/refractive lenses of the second lenses 232a are formed in a cylindrical shape protruding toward the display panel 1 side (Y1 direction side) and their center parts are depressed toward the rear frame 3 side (Y2 direction side). The depressions in the center parts of the reflective/refractive lenses have the shape of a right circular cone with their apexes facing the rear frame 3 side (Y2 direction side). Between the reflective/refractive lenses of the second lenses 232a and the LEDs 232b, depressions are also provided on the display panel 1 side (Y1 direction side). The second lenses 232a are configured to diffuse light more than the first lenses 231a. Thus, in the illustrated embodiment, the first lenses 231a and the second lenses 232a have different light distribution characteristics from each other.

The LEDs 231b and 232b include a plurality of LEDs. The light source boards 231c and 232c are elongated plate-shaped members that extend along the left-right direction (X-direction) of the display device 100. The longitudinal direction of the light source boards 231c and 232c corresponds to the left-right direction (X-direction).

The light source board 231c is provided with the LEDs 231b arranged along the left-right direction (X direction). The light source board 232c is provided with the LEDs 232b arranged along the left-right direction (X direction). The first lenses 231a are provided to cover the LEDs 231b, respectively. The second lenses 232a are provided to cover the LEDs 232b, respectively. Referring to FIGS. 5 to 8, the light distribution characteristics of the first lenses 231a and the second lenses 232a for the light emitted from the LEDs 231b and 232b of the light source unit 23 will be described.

As shown in FIG. 5, the first lenses 231a refract the light irradiated from the LEDs 231b at all angles and diffuse the light. As shown in FIG. 6, the second lenses 232a refract the light irradiated from the LEDs 232b and diffuse the light mainly along the plane extending in the left-right direction (X direction) and the up-down direction (Z direction) of the display device 100.

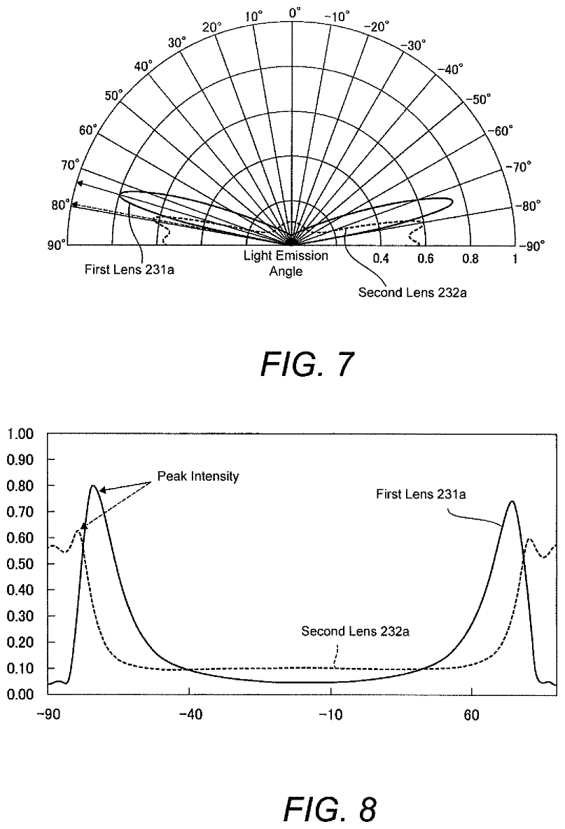

As shown in FIG. 7, the refractive lenses of the first lenses 231a have a reduced amount of light distributed in the direction directly above the LEDs 231b (i.e., 0 degrees of the light emission angle), compared to the reflective/refractive lenses of the second lenses 232a. As shown in FIGS. 7 and 8, the refractive lenses of the first lenses 231a have light distribution peaks around 75 degrees to the left and to the right when the direction directly above the LEDs 231b is set to 0 degrees. The reflective/refractive lenses of the second lenses 232a have light distribution peaks at 80 degrees to the left and to the right when the direction directly above the LEDs 232b is set to 0 degrees. As shown in FIG. 8, the light intensity at the positions of the peaks is stronger for the refractive lenses of the first lenses 231a than for the reflective/refractive lenses of the second lenses 232a.

### (Configuration of Light Reflection Suppressing Portion)

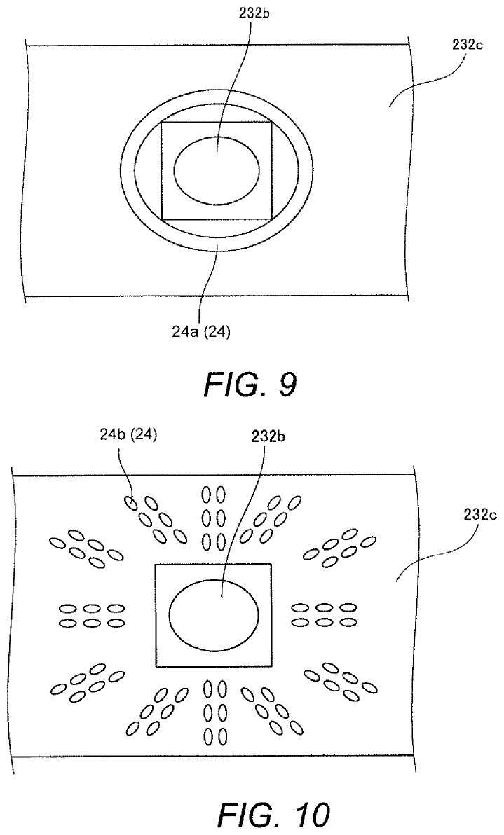

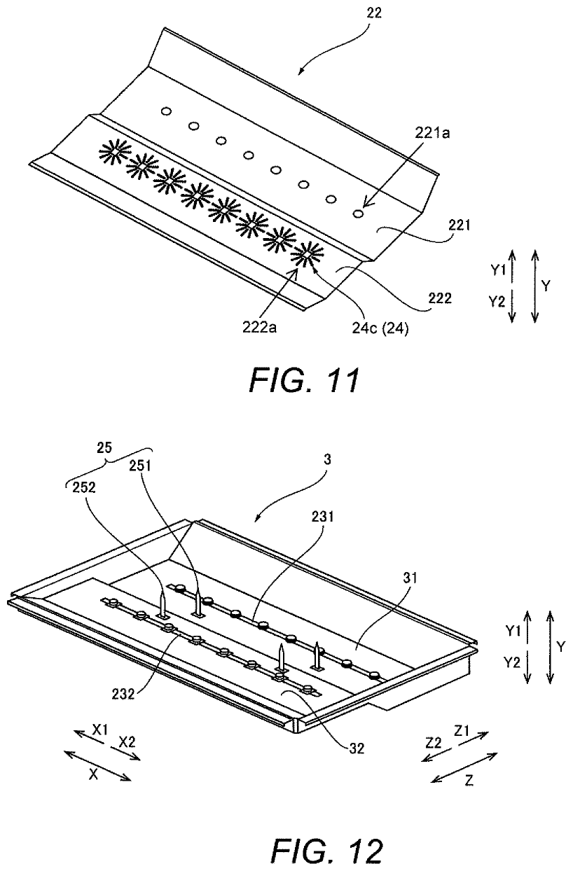

As shown in FIGS. 9 to 11, the light source board 232c of the second light source portion 232 and the second reflective surface 222 of the reflective sheet 22 are provided with light reflection suppressing portions 24 due to the small distance from the optical member 21. The light reflection suppressing portions 24 are provided to suppress reflection and transmission of the light emitted from the LEDs 232b. In the illustrated embodiment, the light reflection suppressing portions 24 include printed patterns or silkscreens disposed on the light source board 232c of the second light source portion 232 and the second reflective surface 222 of the reflective sheet 22. In particular, the printed patterns or silkscreens of the light reflection suppressing portions 24 are printed or deposited using black ink (black silk) or phosphor ink. In the illustrated embodiment, the light reflection suppressing portions 24 include a light reflection suppressing portion 24a provided on the light source board 232c of the second light source portion 232, which is disposed closer to the optical member 21 than the light source board 231c, for each of the LEDs 232b. Specifically, as seen in FIG. 9, the light reflection suppressing portion 24a includes a circular printed pattern or silkscreen that surrounds the LED 232b to suppress reflection and transmission of the light emitted from the LED 232b. Alternatively, the light reflection suppressing portions 24 can include a light reflection suppressing portion 24b provided on the light source board 232c of the second light source portion 232 for each of the LEDs 232b. Specifically, as seen in FIG. 10, the light reflection suppressing portion 24b includes a plurality of dot-shaped printed patterns or silkscreens that are arranged in a radial pattern relative to the LED 232b to suppress reflection and transmission of the light emitted from the LED 232b. Furthermore, in the illustrated embodiment, the reflective sheet 22 is disposed on the front side (Y1 direction side) of the rear frame 3 in the front-rear direction (Y direction) of the display device 100. The light reflection suppressing portions 24 include a light reflection suppressing portions 24c provided on the second reflective surface 222 of the reflective sheet 22 for each of the LEDs 232b. Specifically, as seen in FIG. 11, the light reflection suppressing portions 24c each include a plurality of line-shaped printed patterns or silkscreens that are arranged in a radial pattern relative to the respective one of the openings 222a of the reflective sheet 22 to suppress reflection and transmission of the light emitted from the respective one of the LED 232b provided in the respective one of the openings 222a.

### (Configuration of Panel Post)

As shown in FIG. 12, a plurality sets of panel posts 25 are provided to a first rear section 31 (or first front surface) and a second rear section 32 (or second front surface) of the rear frame 3. Specifically, each of the sets of the panel posts 25 includes a panel post 251 and a panel post 252. The panel post 251 is provided to the first rear section 31 to keep the optical distance, which is the distance between the first light source portion 231 and the optical member 21, uniform at the first distance D1. The panel post 252 is provided to the second rear section 32 to keep the optical distance, which is the distance between the second light source portion 232 and the optical member 21, uniform at the second distance D2. The panel posts 25 are an example of a “columnar spacer member” of the present disclosure. The panel post 251 and the panel post 252 are examples of a “first columnar spacer member” and a “second columnar spacer member”, respectively, of the present disclosure.

The panel posts 25 are components to keep the optical distances (the first distance D1 and the second distance D2) uniform. The panel posts 25 are disposed on the display panel 1 side (Y1 direction side) of the reflective sheet 22. The panel post 251 is disposed on the first reflective surface 221, which is disposed on the display panel 1 side (Y1 direction side) of the first rear section 31 of the rear frame 3. The panel post 252 is disposed on the second reflective surface 222, which is disposed on the display panel 1 side (Y1 direction side) of the second rear section 32 of the rear frame 3.

The panel posts 25 are made of transparent resin. The panel posts 25 include a plate-like member extending in the left-right direction (X direction) and the up-down direction (Z direction) of the display device 100 and a plate-like member extending in the front-rear direction (Y direction) of the display device 100. The panel post 251 is formed so that the length of the plate-like member extending in the front-rear (Y-direction) direction in the display device 100 is longer than the panel post 252. Specifically, the panel post 251 has a length that is equal to or slightly smaller than the first distance D1 in the front-rear direction, while the panel post 252 has a length that is equal to or slightly smaller than the second distance D2 in the front-rear direction.

### (Configuration of Rear Frame)

In the first embodiment, the rear frame 3 has the first rear section 31 and the second rear section 32. The first rear section 31 and the second rear section 32 are offset relative to each other in the front-rear direction of the display device 200 and in the up-down direction of the display device 200. In other words, the first and second rear sections 31 and 32 do not overlap with each other as viewed in the front-rear direction. The first rear section 31 forms a part of a back portion of the rear frame 3 on which the first light source portion 231 that is separated from the optical member 21 by the first distance D1 is disposed. The second rear section 32 forms another part of the back portion of the rear frame 3 on which the second light source portion 232 that is separated from the optical member 21 by the second distance D2 is disposed. The second rear section 32 is disposed closer to the optical member 21 than the first rear section 31. The rear frame 3 further has a step section 33 at the boundary between the first rear section 31 and the second rear section 32. The rear frame 3 is a support member supporting the display panel 1 and the backlight unit 2. The rear frame 3 is provided on the rear side (Y2 direction side) of the display device 100 with respect to the display panel 1 and the backlight unit 2. The first rear section 31 and the second rear section 32 support the first light source portion 231 and the second light source portion 232 on the display panel 1 side (Y1 direction side) thereof, respectively. The first light source portion 231 and the second light source portion 232 are arranged along the left-right direction (X direction) of the rear frame 3, respectively. The first rear section 31 is disposed at the upper portion (Z1 direction side) of the display panel in the up-down direction (Z direction). In other words, the first rear section 31 forms an upper part of the back portion of the rear frame 3. The first rear section 31 and the second rear section 32 differ in distance to the optical member 21. The second rear section 32 is disposed closer to the optical member 21 than the first rear section 31. The step section 33 is provided to extend along the boundary between the first rear section 31 and the second rear section 32 in the left-right direction (X direction). The step section 33 connects the first rear section 31 and the second rear section 32. The rear frame 3 is made of resin or sheet metal. In the illustrated embodiment, the rear frame 3 is integrally formed as a one-piece, unitary member.

The second rear section 32 of the rear frame 3 is disposed at the lower portion of the rear frame 3 in the up-down direction. In other words, the second rear section 32 forms a lower part of the back portion of the rear frame 3. In the illustrated embodiment, as seen in FIG. 3, the step section 33 is inclined relative to the first rear section 31 and the second rear section 32. Specifically, the step section 33 forms a diagonal connection between the first rear section 31 and the second rear section 32.

### (Configuration of Component Part)

The component part 4 is mounted on the rear surface of the second rear section 32 of the rear frame 3, as shown in FIG. 3. The component part 4 includes a circuit board that controls the display device 100. The component part 4 also includes an electrical component that produces sound. Specifically, the component 4 includes at least one of a power supply board 41, a control board 42, and a speaker 43. The power supply board 41 supplies electric power to the display panel 1 and the backlight unit 2. The control board 42 controls the display panel 1 and the backlight unit 2. The speaker 43 outputs audio to be played in the display device 100.

### (Configuration of Rear Cover)

The rear cover 5 is provided to cover a portion of the rear frame 3 and the component part 4 from the rear side. As shown in FIG. 3, the rear cover 5 is provided on the rear side (Z2 direction side) relative to the rear frame 3 and the component part 4. The rear cover 5 is made of resin and is attached to the rear side of the rear frame 3 by screws or other fasteners (not shown).

The rear cover 5 is attached to the rear frame 3 such that the rear surface of the rear cover 5 is flush with or approximately flush with the rear surface of the first rear section 31 of the rear frame 3. In other words, the rear cover 5 is arranged to cover the lower portion of the rear frame 3 in the up-down direction. In particular, the rear cover 5 is arranged to cover the second rear section 32 and the step section 33 of the rear frame 3 from the rear side and from below, as seen in FIG. 3.

### Effect of First Embodiment

The first embodiment has the following effects.

In the first embodiment, as described above, the rear frame 3 has the first rear section 31 on which the first light source portion 231 that is separated from the optical member 21 by the first distance D1 is disposed and the second rear section 32 on which the second light source portion 232 that is separated from the optical member 21 by the second distance D2 is disposed. The second rear section 32 is disposed closer to the optical member 21 than the first rear section 31. With this configuration, the second rear section 32 can be positioned forward (Y1 direction side) relative to the first rear section 31. As a result, a space for arranging necessary component parts can be secured on the rear side of the second rear section. Thus, necessary component parts, such as the control board 42 and the speaker 43, can be arranged in the secured space. As a result, it is possible to prevent that the space for arranging the necessary component parts becomes significantly larger than the thickness of the rear frame 3 in the front-rear direction (Y direction) and that a protrusion protruding rearward (Y2 direction side) from the surface of the display device 100 along the display panel 1 in the front-rear direction (Y direction) of the display device 100 is formed. Thus, the thickness of the display device 100 in the front-rear direction can be prevented from becoming larger. In addition, when the display device 100 is packed for transport or storage, the size of the packaging in the front-rear direction (Y direction) can be prevented from becoming larger. Thus, the space can be saved during transport or storage of the display device 100.

In the first embodiment, as described above, the second lenses 232a are configured to diffuse light more than the first lenses 231a. With this configuration, the light from the second light source portion 232, which is disposed closer to the optical member 21 than the first light source portion 231, can be diffused to a wider angle by the second lenses 232a than by the first lenses 231a. With this configuration, it is possible to prevent that the light irradiated from the second light source portion 232, which is disposed closer to the optical member 21 than the first light source portion 231, is concentrated on a part of the display panel 1 without being diffused. Thus, it is possible to prevent that uneven luminance occurs on the screen of the display panel 1 due to the excessively high luminance at a part of the display panel 1 directly above the second light source portion 232.

In the first embodiment, as described above, the rear frame 3 further has the step section 33 between the first rear section 31 and the second rear section 32. With this configuration, the flat area of the surface connecting the second rear section 32 and the first rear section 31 as viewed in the front-rear direction can be reduced, compared to when the first rear section 31 and the second section 32 are connected by a more gently sloping surface. With this configuration, the second rear section 32 that provides the space for arranging the component parts 4 on the rear side thereof (Y2 direction side) can be made larger.

In the first embodiment, as described above, the display device 100 further comprises the component part 4 disposed on the rear side of the second rear section 32 of the rear frame 3. The display device 100 further comprises the rear cover 5 that covers the component part 4 from the rear side of the display device 100. With this configuration, the component part 4 can be disposed on the rear side of the second rear section 32 that is located forward (Y1 direction side) relative to the first rear section 31 in the rear frame 3. Thus, it is possible to prevent the space for arranging the component part 4 from protruding significantly to the rear side. In addition, the rear cover 5 covers the component part 4 disposed on the rear side of the second rear section 32 that is a part of the rear frame 3. Thus, there is no need to cover the entire rear frame 3 with the rear cover 5. With this configuration, it is possible to prevent the rear cover 5 from becoming larger.

In the first embodiment, as described above, the component part 4 includes the power supply board 41 that supplies electric power to the display panel 1 and the backlight unit 2, the control board 42 that controls the display panel 1 and the backlight unit 2, and the speaker 43. With this configuration, the power supply board 41, the control board 42 and the speaker 43 can be disposed in the space on the rear side of the second rear section 32. In addition, the component part 4 is not disposed on the periphery of the display panel 1. Thus, it is possible to prevent the frame around the periphery of the display panel 1 from becoming larger.

In the first embodiment, as described above, the rear cover 5 is attached to the rear frame 3 such that the rear surface of the rear cover 5 is flush with or approximately flush with the rear surface of the first rear section 31 of the rear frame 3. With this configuration, the position of the rear side of the display device 100 can be aligned with the position of the rear surface of the first rear section 31 of the rear frame 3. Thus, it is possible to effectively prevent the increase in the thickness of the display device 100 in the front-rear direction (Y direction). In addition, it is possible to prevent the formation of a protruding portion on the rear side of the display device 100. Thus, there is no need to increase the size of the packing material used to pack the display device 100 to match the size of the protruding portion. With this configuration, it is possible to effectively prevent the increase in the size of the packing material in the front-rear direction (Y-direction).

In the first embodiment, as described above, the first light source portion 231 and the second light source portion 232 include the LEDs 231b and 232b that emit light and the light source boards 231c and 232c on which the LEDs 231b and 232b (the light emitting elements) are arranged, respectively. The backlight unit 2 also includes the reflective sheet 22 (reflective member) that reflects the light from the light source unit 23 toward the display panel 1. At least one of the light source board 232c of the second light source portion 232 and a part of the reflective sheet 22 that is disposed on the second rear section 32 of the rear frame 3 includes the light reflection suppressing portions 24 to suppress reflection of light. With this configuration, the light from the light source unit 23 can be efficiently incident on the optical member 21 by being reflected by the reflective sheet 22. In addition, it is possible to suppress the reflection of light from the second light source portion 232 that is disposed closer to the optical member 21 than the first light source portion 232 by the light reflection suppressing portions 24 (24a, 24b, and 24c). Thus, it is possible to effectively prevent the light from the second light source portion 232 that is disposed closer to the optical member 21 than the first light source portion 231 from being concentrated in a portion without diffusion. As a result, it is possible to effectively prevent uneven luminance from occurring on the screen of the display panel I due to excessively high luminance of a part of the display panel 1 directly above the second light source portion 232.

In the first embodiment, as described above, the second rear section 32 of the rear frame 3 is disposed at the lower portion (Z2 direction side) of the rear frame 3 in the up-down direction (Z direction). With this configuration, the second rear section 32 can be disposed at an end portion of the rear frame 3 in the up-down direction (Z direction) and in the left-right direction (X direction). Thus, it is possible to provide the space for arranging necessary component part 4 at the end portion of the rear frame 3 in the up-down direction (Z direction) on the rear side of the rear frame 3.

In the first embodiment, as described above, the backlight unit 2 includes the panel posts 25 (columnar spacer members) to maintaining a uniform distance between the light source unit 23 and the optical member 21. The panel posts 25 each include the panel post 251 (first columnar spacer member) that is disposed on the first rear section 31 and the panel post 252 (second columnar spacer member) that is disposed on the second rear section 32. The panel post 251 is longer in the front-rear direction (Y direction) than the panel post 252. With this configuration, the panel post 251 can maintain the first distance D1 between the first light source portion 231 that is disposed on the first rear section 31 and the optical member 21 uniform, and the panel post 252 can maintain the second distance D2 between the second light source portion 232 that is disposed on the second rear section 32 and the optical member 21 uniform. As a result, the state of irradiation of light from the light source unit 23 can be maintained. Thus, it is possible to prevent uneven luminance from occurring due to the change in the state of light irradiated to the display panel 1.

### Second Embodiment

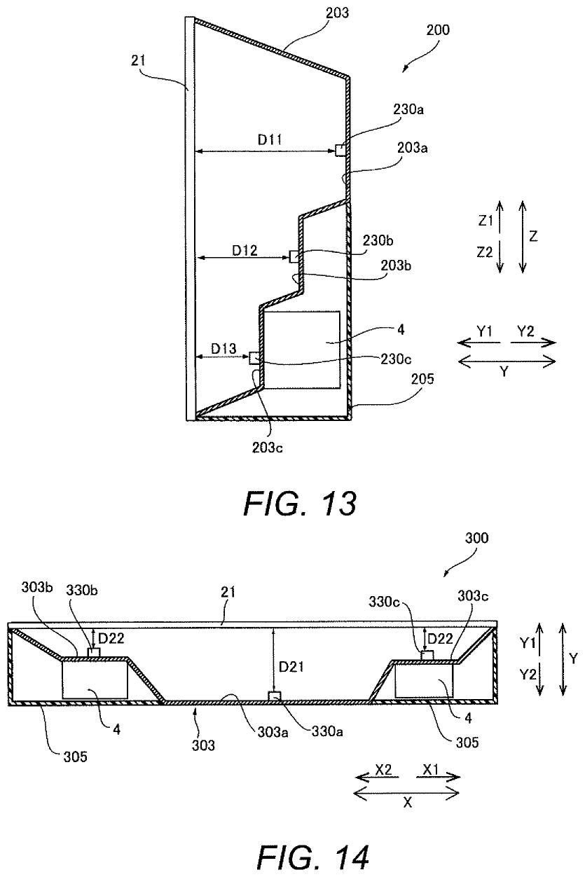

Next, a second embodiment of the disclosure is described with reference to FIG. 13. In this second embodiment, unlike the above-mentioned first embodiment in which the backlight unit 2 includes the first and second light source portions 231 and 232 arranged at two mutually different optical distances, an example will be discussed in which a backlight unit includes a plurality of light source portions arranged at three mutually different optical distances. The same configuration as in the above-mentioned first embodiment is illustrated with the same symbol in the drawings and its explanation will be omitted.

A display device 200 according to the second embodiment comprises the display panel 1 (see FIG. 1), the backlight unit 2 (see FIG. 2), a rear frame 203, the component part 4, and a rear cover 205, as shown in FIG. 13. The display panel 1 and the component part 4 are basically identical to the display panel 1 and the component part 4 according to the first embodiment. The backlight unit 2 is basically identical to the backlight unit 2 according to the first embodiment, except that the backlight unit 2 according to the second embodiment includes a light source unit having a first light source portion 230a, a second light source portion 230b and a third light source portion 230c and a reflective sheet in the form corresponding to the rear frame 203.

The rear frame 203 includes a first rear section (or front surface) 203a, a second rear section (or front surface) 203b, and a third rear section (or front surface) 203c. The first, second and third rear sections 203a, 203b and 203c are offset relative to each other in the front-rear direction of the display device 200 and in the up-down direction of the display device 200. In other words, the first, second and third rear sections 203a, 203b and 203c do not overlap with each other as viewed in the front-rear direction. The rear frame 203 also includes a first step section between the first rear section 203a and the second rear section 203b and a second step section between the second rear section 203b and the third rear section 203c. The backlight unit 2 includes the first light source portion 230a, the second light source portion 230b, and the third light source portion 230c.

The first light source portion 230a is disposed on the first rear section 203a. The second light source portion 230b is disposed on the second rear section 203b. The third light source portion 230c is disposed on the third rear section 203c.

The first light source portion 230a is disposed at a position separated from the optical member 21 by a first distance D11. The second light source portion 230b is disposed at a position separated from the optical member 21 by a second distance D12. The third light source portion 230c is disposed at a position separated from the optical member 21 by a third distance D13. The second distance D12 is smaller than the first distance D11. The third distance D13 is smaller than the first distance D11 and the second distance D12. In other words, the distances between the optical member 21 and the first, second and third light source portions 230a, 230b and 230c becomes smaller in the order of the first distance D11, the second distance D12, and the third distance D13. The first, second and third light source portions 230a, 230b and 230c are basically identical to the first and second light source portions 231 and 232, except that the first, second and third light source portions 230a, 230b and 230c have lenses with different light distribution characteristics from the first and second lenses 231a and 232a according to their optical distances (i.e., the first, second and third distances D11, D12 and D13).

In the second embodiment, the rear frame 203 has the first rear section 203a on which the first light source portion 230a that is separated from the optical member 21 by the first distance D11 is disposed, the second rear section 203b on which the second light source portion 230b that is separated from the optical member 21 by the second distance D12 is disposed, and the third rear section 203c on which the third light source portion 230c that is separated from the optical member 21 by the third distance D13 is disposed. The second rear section 203b is disposed closer to the optical member 21 than the first rear section 203a. The third rear section 203c is disposed closer to the optical member 21 than the first rear section 203a and the second rear section 203b. In other words, the rear frame 203 is disposed close to the optical member 21 in the order of the first rear section 203a, the second rear section 203b and the third rear section 203c. Furthermore, the first rear section 203a is disposed above the second rear section 203b, and the second rear section 203b is disposed above the third rear section 203c. In the illustrated embodiment, the reflective sheet is also provided such that the reflective sheet extends at least along front surfaces of the first rear section 203a, the first step section, the second rear section 203b, the second step section and the third rear section 203c.

The rear cover 205 is arranged to cover a portion of the rear frame 203 and the component part 4 from the rear side. Specifically, the rear cover 205 is attached to the rear frame 203 such that the rear surface of the rear cover 205 is flush with or approximately flush with the rear surface of the first rear section 203a of the rear frame 203. The rear cover 205 is arranged to cover the lower portion of the rear frame 203 in the up-down direction. The rear cover 205 is arranged to cover the rear side of the second rear section 203b and the third rear section 203c of the rear frame 203 from the rear side. Thus, a space for arranging the component part 4 can be formed between the second rear section 203b and the rear cover 205 and between the third rear section 203c and the rear cover 205.

Other configurations of the second embodiment are the same as the above-mentioned first embodiment.

### Effect of Second Embodiment

In the second embodiment, as in the first embodiment, it is possible to prevent the thickness of the display device 200 in the front-rear direction (Y direction) from becoming larger.

In the second embodiment, the first rear section 203a, the second rear section 203b, and the third rear section 203c are provided so that the distance between the rear frame 203 and the optical member 21 varies in three steps. With this configuration, relatively large component parts can be placed in the space on the rear side of the third rear section 203c, where the space is relatively larger, and relatively small component parts can be placed in the space on the rear side of the second rear section 203b.

Other effects of the second embodiment are the same as those of the above-mentioned first embodiment.

### Third Embodiment

Next, a third embodiment of the disclosure is described with reference to FIG. 14. In this third embodiment, unlike the above-mentioned first embodiment in which the second rear section 32 is disposed in the lower portion (Z2 direction side) of the rear frame 3 in the up-down direction (Z direction), an example will be described in which second rear sections are located at both end portions of a rear frame in the left-right direction. The same configuration as in the above-mentioned first embodiment is illustrated with the same symbols in the drawings, and the explanation will be omitted.

A display device 300 according to the third embodiment has the display panel 1 (see FIG. 1), the backlight unit 2 (see FIG. 2), a rear frame 303, the component parts 4, and rear covers 305, as shown in FIG. 14. The display panel 1 and the component parts 4 are basically identical to the display panel 1 and the component part 4 according to the first embodiment. The backlight unit 2 is basically identical to the backlight unit 2 according to the first embodiment, except that the backlight unit 2 according to the third embodiment includes a light source unit having a first light source portion 330a and a pair of second light source portions 330b and 330c and a reflective sheet in the form corresponding to the rear frame 303.

The rear frame 303 includes a first rear section (or front surface) 303a and a pair of second rear sections (or front surfaces) 303b and 303c. The second rear sections 303b and 303c are disposed at both end portions of the rear frame 303 in the left-right direction, respectively. Thus, as seen in FIG. 14, the second rear sections 303b and 303c sandwich the first rear section 303a therebetween in the left-right direction of the display device 300. Furthermore, the first rear section 303a and the second rear sections 303b and 303c are offset relative to each other in the front-rear direction of the display device 200 and in the left-right direction of the display device 200. In other words, the first rear section 303a and the second rear sections 303b and 303c do not overlap with each other as viewed in the front-rear direction. The rear frame 203 also includes a pair of step sections between the first rear section 303a and the second rear section 303b and between first rear section 303a and the second rear section 303c. The backlight unit 2 includes the first light source portion 330a and the second light source portions 330b and 330c that are disposed on the first rear section 303a and the second rear sections 303b and 303c, respectively, as shown in FIG. 14.

The first light source portion 330a is disposed at a position separated from the optical member 21 by a first distance D21. The second light source portions 330b and 330c are disposed at positions separated from the optical member 21 by a second distance D22. The second distance D22 is smaller than the first distance D21. In other words, the second light source portions 330b and 330c are disposed closer to the optical member 21 than the first light source portion 330a. The first and second light source portions 330a, 330b and 330c are basically identical to the first and second light source portions 231 and 232, except that the first and second light source portions 330a, 330b and 330c have lenses with different light distribution characteristics from the first and second lenses 231a and 232a according to their optical distances (i.e., the first and second distances D21 and D22 and that the first and second light source portions 330a, 330b and 330c are arranged such that the longitudinal directions of their light source boards correspond to the up-down direction of the display device 300.

In the third embodiment, the rear frame 303 has the first rear section 303a on which the first light source portion 330a that is separated from the optical member 21 by the first distance D21 is disposed, and the second rear sections 303b and 303c on which the second light sources 330b and 330c that are separated from the optical member 21 by the second distance D22 are disposed. The second rear sections 303b and 303c are positioned closer to the optical member 21 than the first rear section 303a. Furthermore, the first rear section 303a is disposed between the second rear sections 303b and the second rear section 303c in the left-right direction. In the illustrated embodiment, the reflective sheet is also provided such that the reflective sheet extends at least along front surfaces of the second rear section 303b, the step section between the second rear section 303b and the first rear section 303a, the first rear section 303a, the step section between the first rear section 303a and the second rear section 303c and the second rear section 303c.

The rear covers 305 is arranged to cover end portions of the rear frame 303 and the component parts 4 from the rear side, respectively. Specifically, the rear cover 305 is attached to the rear frame 303 so that the rear surface of the rear covers 305 are flush with or approximately flush with the rear surface of the first rear section 303a of the rear frame 303. The rear covers 305 are arranged to cover both end portions of the rear frame 303 in the left-right direction. The rear cover 305 is arranged to cover the rear sides of the second rear sections 303b and 303c of the rear frame 303 from the rear side, respectfully. Thus, spaces for arranging the component parts 4, respectively, can be formed between the second rear sections 303b and 303c and the rear covers 205, respectively.

Other configurations of the third embodiment are the same as the above-mentioned first embodiment.

### Effect of Third Embodiment

In the third embodiment, as in the first embodiment, it is possible to prevent the thickness of the display device 300 in the front-rear direction (Y direction) from becoming larger.

In the third embodiment, as described above, the second rear sections 303b and 303c are disposed at both end portions of the rear frame 303 in the left-right direction. With this configuration, the second rear sections 303b and 303c can be disposed at the end portions of the rear frame 303 in the left-right direction. Thus, the spaces for arranging necessary component parts 4 can be secured at the rear side of the end portions of the rear frame 303 in the left-right direction. In addition, the spaces are provided at the end portions in the left-right direction. Thus, the two component parts 4 can be installed at two separate spaces while suppressing the thickness of the display device 303 in the front-rear direction.

Other effects of the third embodiment are the same as those of the above-mentioned first embodiment.

### Fourth Embodiment

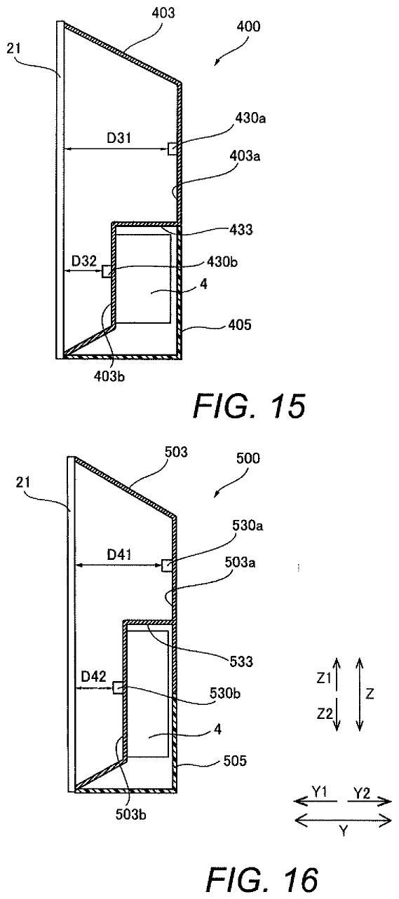

Next, the fourth embodiment of the disclosure is described with reference to FIG. 15. In this fourth embodiment, unlike the above-mentioned first embodiment in which the first rear section 31 and the second rear section 32 are connected by the inclined step section 33, an example will be described in which a step section extends parallel to a plane along the front-rear direction (Y direction) of a display device and perpendicular to a front surface of a first rear section and a front surface of the second rear section. The same configuration as in the above-mentioned first embodiment is illustrated with the same symbols in the drawings, and the explanation will be omitted.

A display device 400 according to the fourth embodiment has the display panel 1 (see FIG. 1), the backlight unit 2 (see FIG. 2), a rear frame 403, the component part 4, and a rear cover 405, as shown in FIG. 15. The display panel 1 and the component part 4 are basically identical to the display panel 1 and the component part 4 according to the first embodiment. The backlight unit 2 is basically identical to the backlight unit 2 according to the first embodiment, except that the backlight unit 2 according to the fourth embodiment includes a light source unit having a first light source portion 430a and a second light source portion 430b and a reflective sheet in the form corresponding to the rear frame 403.

The rear frame 403 of the fourth embodiment includes a first rear section (or front surface) 403a and a second rear section (or front surface) 403b. The first and second rear sections 403a and 403b are offset relative to each other in the front-rear direction of the display device 400 and in the up-down direction of the display device 400. In other words, the first and second rear sections 403a and 403b do not overlap with each other as viewed in the front-rear direction. The rear frame 403 also includes a step section 433 between the first rear section 403a and the second rear section 403b. The step section 433 is parallel to a plane along the front-rear direction (Y direction) of the display device 400 and perpendicular to the first rear section 403a and the second rear section 403b. Thus, the step section 433 forms a perpendicular connection between the first rear section 403a and the second rear section 403b. The backlight unit 2 includes the first light source portion 430a and the second light source portion 430b that are disposed on the first rear section 403a and the second rear section 403b, respectively, as shown in FIG. 15.

The first light source portion 430a is disposed at a position separated from the optical member 21 by a first distance D31. The second light source portion 430b is disposed at a position separated from the optical member 21 by a second distance D32. The second distance D32 is smaller than the first distance D31. The first and second light source portions 430a and 430b are basically identical to the first and second light source portions 231 and 232, except that the first and second light source portions 430a and 430b have lenses with different light distribution characteristics from the first and second lenses 231a and 232a according to their optical distances (i.e., the first and second distances D31 and D32).

In the fourth embodiment, the rear frame 403 has the first rear section 403a on which the first light source portion 430a that is separated from the optical member 21 by the first distance D31 is disposed, and the second rear section 403b on which the second light source portion 430b that is separated from the optical member 21 by the second distance D32 is disposed. The second rear section 403b is positioned closer to the optical member 21 than the first rear section 403a. Furthermore, the first rear section 403a is disposed above the second rear section 403b. In the illustrated embodiment, the reflective sheet is also provided such that the reflective sheet extends at least along front surfaces of the first rear section 403a, the step section 433 and the second rear section 403b.

The rear cover 405 is arranged to cover a portion of the rear frame 403 and the component part 4 from the rear side. Specifically, the rear cover 405 is attached to the rear frame 403 so that the rear surface of the rear cover 405 is flush with or approximately flush with the rear surface of the first rear section 403a of the rear frame 303. The rear cover 405 is arranged to cover the lower portion of the rear frame 403 in the up-down direction. The rear cover 405 is arranged to cover the rear side of the second rear section 403b of the rear frame 403. Thus, a space for arranging the component part 4 can be formed between the second rear section 403b and the rear cover 405.

Other configurations of the fourth embodiment are the same as the above-mentioned first embodiment above.

### Effect of Fourth Embodiment

In the fourth embodiment, as in the first embodiment, it is possible to prevent the thickness of the display device 400 in the front-rear direction (Y direction) from becoming larger.

In the fourth embodiment, as described above, the step 433 is parallel to the plane along the front-rear direction (Y direction) of the display device 400 and perpendicular to the first rear section 403a and the second rear section 403b. With this configuration, the distance of the connection between the first rear section 403a and the second rear section 403b can be reduced, compared to when the first rear section 403a and the second rear section 403b are connected by a gently sloping surface. With this configuration, the second rear section 403b that can provide the space on the rear side thereof can be made larger.

Other effects of the fourth embodiment are the same as those of the above-mentioned first embodiment.

### Fifth Embodiment

Next, the fifth embodiment of the disclosure will be described with reference to FIG. 16. In this fifth embodiment, unlike the above-mentioned first embodiment in which the rear cover 5 covers the component part 4 that is disposed on the rear side of the second rear section 32, an example will be described in which a rear cover and a rear frame cover the component part 4 that disposed on the rear side of a second rear section. The same configuration as in the above-mentioned first embodiment is illustrated with the same symbols in the drawings, and the explanation will be omitted.

A display device 500 according to the fifth embodiment has the display panel 1 (see FIG. 1), the backlight unit 2 (see FIG. 2), a rear frame 503, the component part 4, and a rear cover 505, as shown in FIG. 16. The display panel 1 and the component part 4 are basically identical to the display panel 1 and the component part 4 according to the first embodiment. The backlight unit 2 is basically identical to the backlight unit 2 according to the first embodiment, except that the backlight unit 2 according to the fifth embodiment includes a light source unit having a first light source portion 530a and a second light source portion 530b and a reflective sheet in the form corresponding to the rear frame 503.

The rear frame 503 of the fifth embodiment includes a first rear section (or front surface) 503a and a second rear section (or front surface) 503b. The rear frame 503 also includes a step section 533 between the first rear section 503a and the second rear section 503b. The step section 533 is parallel to a plane along the front-rear direction (Y direction) of the display device 500 and perpendicular to the first rear section 503a and the second rear section 503b. Thus, the step section 533 forms a perpendicular connection between the first rear section 503a and the second rear section 503b. A portion (e.g., an upper portion) of the second rear section 503b is covered by a portion (e.g., a lower portion) of the first rear section 503a. In particular, an upper portion of the first rear section 503a is disposed above the second rear section 503b, and the first rear section 503a extends downward beyond the step section 533 in the up-down direction to partially overlap the second rear section 503b as viewed in the front-rear direction. The backlight unit 2 includes the first light source portion 530a and the second light source portion 530b that are disposed on the first rear section 503a and the second rear section 503b, respectively, as shown in FIG. 16.

The first light source portion 530a is disposed at a position separated from the optical member 21 by a first distance D41. The second light source portion 530b is disposed at a position separated from the optical member 21 by a second distance D42. The second distance D42 is smaller than the first distance D41. The first and second light source portions 530a and 530b are basically identical to the first and second light source portions 231 and 232, except that the first and second light source portions 530a and 530b have lenses with different light distribution characteristics from the first and second lenses 231a and 232a according to their optical distances (i.e., the first and second distances D41 and D42).

In the fifth embodiment, the rear frame 503 has the first rear section 503a on which the first light source portion 530a that is separated from the optical member 21 by the first distance D41 is disposed, and the second rear section 503b on which the second light source portion 530b that is separated from the optical member 21 by the second distance D42 is disposed. The second rear section 503b is positioned closer to the optical member 21 than the first rear section 503a. Furthermore, the reflective sheet is also provided such that the reflective sheet extends at least along front surfaces of the upper portion of the first rear section 503a, the step section 533 and the second rear section 403b.

The rear cover 505 is arranged to cover a portion of the rear frame 503 and the component part 4 from the rear side. Specifically, the rear cover 505 is attached to the rear frame 503 so that the rear surface of the rear cover 505 is flush with or approximately flush with the rear surface of the first rear section 503a of the rear frame 503. The rear cover 505 is arranged to cover the lower portion of the rear frame 503 in the up-down direction. The rear cover 505 is arranged to cover a lower portion of the second rear section 503b of the rear frame 503 from the rear side. Thus, a space for arranging the component part 4 can be formed between the upper portion of the second rear section 503b and the lower portion of the first rear section 503b and between the lower portion of the second rear section 503b and the rear cover 505.

Other configurations of the fifth embodiment are the same as the above-mentioned first embodiment.

### Effect of Fifth Embodiment

In the fifth embodiment, as in the first embodiment, it is possible to prevent the thickness of the display device 500 in the front-rear direction (Y direction) from becoming larger.

In the fifth embodiment, as described above, a portion (the upper portion) of the second rear section 503b is covered by a portion (the lower portion) of the first rear section 503a. With this configuration, the area of the rear cover 505 can be made smaller, compared to when the second rear section 503b is entirely covered by the rear cover 505. With this configuration, it is possible to effectively reduce the area of the rear cover 505.

Other effects of the fifth embodiment are the same as those of the above-mentioned first embodiment.

### Sixth Embodiment

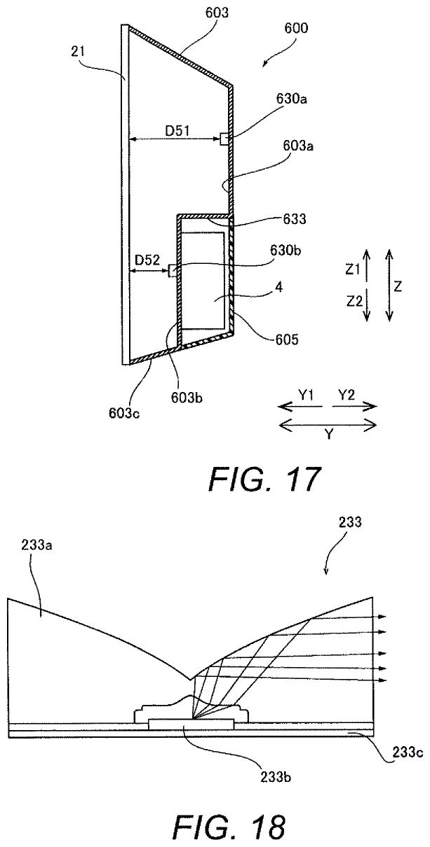

Next, the sixth embodiment of the disclosure is described with reference to FIG. 17. In this sixth embodiment, unlike the above-mentioned first embodiment in which a lower surface of a bottom section of the rear cover 5 extends along the horizontal direction, an example will be described in which a lower surface of a bottom section of a rear cover extends upward toward the rear side in the same inclined manner as a lower surface of a bottom section of a rear frame. The same configuration as in the above-mentioned first embodiment is illustrated with the same symbol in the drawings and its explanation will be omitted.

A display device 600 according to the sixth embodiment has the display panel 1 (see FIG. 1), the backlight unit 2 (see FIG. 2), a rear frame 603, the component part 4, and a rear cover 605, as shown in FIG. 17. The display panel 1 and the component part 4 are basically identical to the display panel 1 and the component part 4 according to the first embodiment. The backlight unit 2 is basically identical to the backlight unit 2 according to the first embodiment, except that the backlight unit 2 according to the sixth embodiment includes a light source unit having a first light source portion 630a and a second light source portion 630b and a reflective sheet in the form corresponding to the rear frame 603.

The rear frame 603 of the sixth embodiment includes a first rear section (or front surface) 603a, a second rear section (or front surface) 603b and a bottom section 603c. The bottom section 603c includes a lower surface (or lower inclined surface) that is inclined upward as moving rearward and is connected to a lower edge of the second rear section 603b that located on the lower side (Z2 direction side) out of the edges of the second rear section 603b that extend along the left-right direction (X direction) of the display device 600. The rear frame 603 also includes a step section 633 between the first rear section 603a and the second rear section 603b. The step section 633 is parallel to a plane along the front-rear direction (Y direction) of the display device 600 and perpendicular to the first rear section 603a and the second rear section 603b. Thus, the step section 633 forms a perpendicular connection between the first rear section 603a and the second rear section 603b. The backlight unit 2 includes the first light source portion 630a and the second light source portion 630b that are disposed on the first rear section 603a and the second rear section 603b, respectively, as shown in FIG. 17.

The first light source portion 630a is disposed at a position separated from the optical member 21 by a first distance D51. The second light source portion 630b is disposed at a position separated from the optical member 21 by a second distance D52. The second distance D52 is smaller than the first distance D51. The first and second light source portions 630a and 630b are basically identical to the first and second light source portions 231 and 232, except that the first and second light source portions 630a and 630b have lenses with different light distribution characteristics from the first and second lenses 231a and 232a according to their optical distances (i.e., the first and second distances D51 and D52).

In the sixth embodiment, the rear frame 603 has the first rear section 603a on which the first light source portion 630a that is separated from the optical member 21 by the first distance D51 is disposed, and the second rear section 603b on which the second light source portion 630b that is separated from the optical member 21 by the second distance D52 is disposed. The second rear section 603b is positioned closer to the optical member 21 than the first rear section 603a. Furthermore, the first rear section 603a is disposed above the second rear section 603b. In the illustrated embodiment, the reflective sheet is also provided such that the reflective sheet extends at least along front surfaces of the first rear section 603a, the step section 633 and the second rear section 603b.

The rear cover 605 is arranged to cover a portion of the rear frame 603 and the component part 4 from the rear side. Specifically, the rear cover 605 is attached to the rear frame 603 so that the rear surface of the rear cover 605 is flush with or approximately flush with the rear surface of the first rear section 603a of the rear frame 603. The rear cover 605 is also attached to the rear frame 603 so that the lower surface of the bottom section of the rear cover 605 is flush with or approximately flush with the lower surface of the bottom section 603c of the rear frame 603. The rear cover 605 is arranged to cover a lower portion of the rear frame 603 in the up-down direction. The rear cover 605 is arranged to cover the rear side of the second rear section 603b of the rear frame 603. Thus, a space for arranging the component part 4 can be formed between the second rear section 403b and the rear cover 405. The rear cover 605 is formed such that the lower surface of the bottom section of the rear cover 605 extends upward toward the rear side in the same inclined manner as the lower surface of the bottom section 603c of the rear frame 603.

Other configurations of the sixth embodiment are the same as the above-mentioned first embodiment.

### Effect of Sixth Embodiment

In the sixth embodiment, as in the first embodiment, it is possible to prevent the thickness of the display device 600 in the front-rear direction (Y direction) from becoming larger.

In the sixth embodiment, as described above, the rear cover 605 covers the component part 4 from the rear side (Y2 direction side) in a state in which the rear cover 605 is arranged such that the lower surface (lower inclined surface) of the rear cover 605 is flush with or approximately flush with the lower surface of the bottom section 603c of the rear frame 603. With this configuration, it is possible to align the position of the lower surface side of the display device 600 in the up-down direction (Z direction) with the position of the lower surface (lower inclined surface) of the bottom section 603c of the rear frame 603, which is a bottom surface of the rear frame 603 in the up-down direction (Z direction). With this configuration, the area of the rear cover 605 can be made smaller, compared to when the rear cover 605 is formed without considering the bottom surface of the rear frame 603 in the up-down direction (Z direction). As a result, the area of the rear cover 605 can be effectively reduced.

Other effects of the sixth embodiment are the same as those of the above-mentioned first embodiment.

### Modifications

The embodiments disclosed herein are just examples in every respect, and should not be interpreted as being limiting in nature. The scope of the invention being indicated by the claims rather than by the above description of the embodiments, all modifications (modification examples) within the meaning and range of equivalency of the claims are included.

For example, in the above-mentioned first embodiment, an example is shown in which the first and second light source portions 231 and 232 are arranged along the left-right direction (X direction) of the rear frame 3, but the present invention is not limited to this. They may be arranged along the up-down direction (Z direction) of the rear frame 3.

In the first embodiment, an example is shown in which the step section 33 is provided at the boundary between the first rear section 31 and the second rear section 32 of the rear frame 3, but the present invention is not limited to this. The first rear section 31 and the second rear section 32 may be connected by a curved or gently sloping surface so that there is no step between the first rear section 31 and the second rear section 32.

In the above-mentioned first embodiment, an example is shown in which the first light source portion 231 and the second light source portion 232 each include a lens, but the present invention is not limited to this. For the first light source portion 231 whose optical distance to the optical member 21 is larger than the second light source portion 232, a lens may not be used.

In the above-mentioned first embodiment, an example is shown in which the refractive lenses are used for the first lenses 231a and the reflective/refractive lenses are used for the second lenses 232a, but the combination of lenses in the present invention is not limited to this. In addition to or in replace of the refractive lenses and the reflective/refractive lenses, a reflective lens may be used as shown in a first modification in FIG. 18, for example. FIG. 18 shows a lens 233 according to the first modification, which includes a reflective lens 233a, an LED 233b, and a light source board 233c. A transparent resin may also be used as a substitute for the lens by potting it into a dome lens shape.

In the above-mentioned first embodiment, an example is shown in which the component part 4 includes the power supply board 41, the control board 42, and the speaker 43, but the present invention is not limited to this. In the present invention, for example, the component part 4 may include a wireless LAN module, a tuner for receiving broadcast signals, and a control circuit including a processor. The component part 4 may also include only one or two of a power supply board that supplies electric power to the display panel 1 and the backlight unit 2, a control board that controls the display panel 1 and the backlight unit 2, and a speaker.

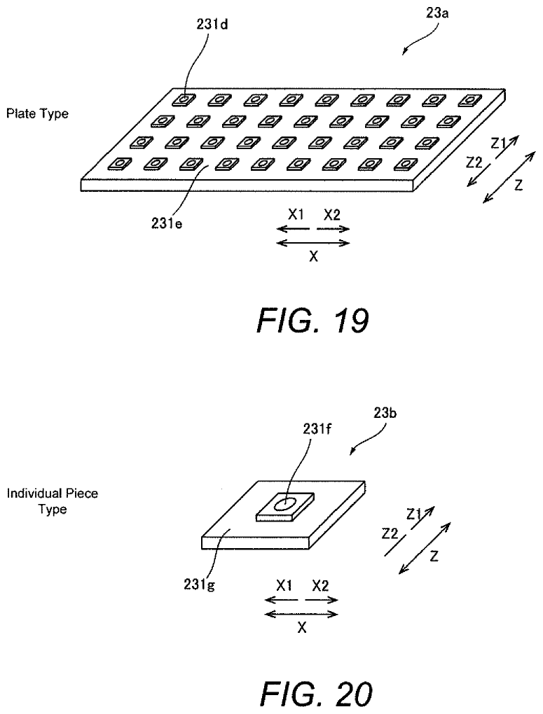

In the above-mentioned first embodiment, an example is shown in which the light source unit 23 is in the form of a rod-shaped plate extending in the left-right direction (X direction) of the display device 100, but the present invention is not limited to this. For example, as shown in a second modification in FIG. 19, a light source unit 23a may include a plurality of LEDs 231d and a light source board 231e. As shown in FIG. 19, with the light source unit 23a, the light source board 231e is in the form of a plate extending in the left-right direction (X direction) and the up-down direction (Z direction) of the display device. The LEDs 231d are arranged above the light source board 231e such that the LEDs 231d are arranged in the left-right direction (X direction) and the up-down direction (Z direction) of the display device, as shown in FIG. 19. As shown in a third modification in FIG. 20, a light source unit 23b may include a LED 231f and a light source board 231g. The light source unit 23b is in the form of an individual piece including one LED 231f and one light source board 231g, as shown in FIG. 20.

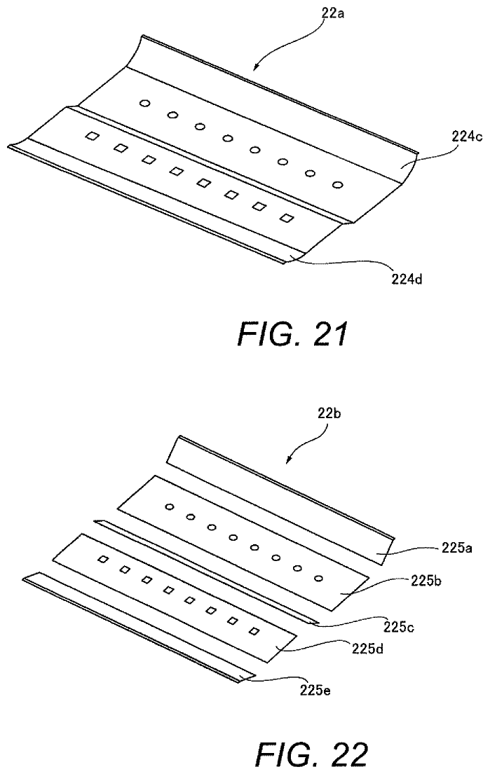

In the above-mentioned first embodiment, an example is shown in which the reflective sheet 22 is formed of a single rectangular sheet, but the present invention is not limited to this. As shown in a fourth modification in FIG. 21, the reflective sheet 22a can include end inclined portions 224c and 224d that are formed with curved surfaces at end portions of the reflective sheet 22a. As also shown in a fifth modification in FIG. 22, a reflective sheet 22b may be divided into five reflective sheets 225a, 225b, 225c, 225d, and 225e.

In the above-mentioned first and third embodiments, examples are shown in which the second rear section of the rear frame is located at the lower portion of the rear frame in the up-down direction and at least one of both end portions in the left-right direction, but the present invention is not limited to this. In the present invention, for example, the first to sixth embodiments are shown as independent embodiments, but these embodiments may be arbitrarily combined with respect to the arrangement of the second rear section.

In the above-mentioned first embodiment, an example is shown in which the rear cover 5 is provided to cover a portion of the rear frame 3 and the component part 4 from the rear side, but the present invention is not limited to this. In the present invention, for example, the rear cover may be configured to cover the component part from the rear side in a state in which the rear cover is arranged so that it is flush with or approximately flush with the rear surface of the first section of the rear frame.

(1) In view of the state of the known technology, a display device according to an aspect of this disclosure comprises a display panel with a display surface, a backlight unit, and a rear frame. The backlight unit is configured to irradiate light to the display panel from a rear side of the display panel. The backlight unit includes a light source unit that is configured to emit light and a sheet-like optical member that is configured to diffuse the light from the light source unit toward a rear surface of the display panel. The rear frame covers the backlight unit from a rear side of the display device. The light source unit has a first light source that is disposed spaced apart from the optical member in a front-rear direction of the display device and is provided with a first lens, and a second light source that is disposed spaced apart from the optical member and closer to the optical member than the first light source in the front-rear direction and is provided with a second lens. The first lens and the second lens have different light distribution characteristics from each other.

(2) In accordance with a preferred embodiment according to the display device mentioned above, the rear frame has a first rear section on which the first light source is disposed, and a second rear section on which the second light source is disposed, the second rear section being disposed closer to the optical member than the first rear section.

(3) In accordance with a preferred embodiment according to any one of the display devices mentioned above, the rear frame is provided to face the optical member.

In the display device according to the aspect of this disclosure, the rear frame has the first rear section on which the first light source that is disposed spaced apart from the optical member is disposed and the second rear section on which the second light source that is disposed spaced apart from the optical member is disposed, and the second rear section is disposed closer to the optical member than the first rear section. With this configuration, the second rear section of the rear frame can be positioned forward relative to the first rear section of the rear frame. Thus, a space for arranging necessary component parts can be secured on the rear side of the second rear section of the rear frame. With this configuration, necessary component parts, such as a control unit that controls each member and a speaker, can be placed on the rear side of the second rear section of the rear frame. As a result, it is possible to prevent that the space for arranging the necessary component parts becomes significantly larger than the thickness of the rear frame in the front-rear direction and that a protrusion protruding rearward from a surface of the display device along the display panel in the front-rear direction of the display device is formed. Thus, the thickness of the display device in the front-rear direction can be prevented from becoming larger. As a result, when the display device is packed for transport or storage, the size of the packaging in the front-rear direction can be prevented from becoming larger, and thus the space can be saved during transport or storage of the display device. In addition, the first lens that distributes light is provided in the first light source, and the second lens that distributes light according to different light distribution characteristics from the first lens is provided in the second light source. With this configuration, the light can be distributed from the light source unit according to the distance between the light source unit and the optical member. Thus, uneven luminance on the display panel can be suppressed by the light irradiated from the first and second light sources that are disposed at different distances from the optical member.

(4) In accordance with a preferred embodiment according to the display device mentioned above, the second lens is configured to diffuse light more than the first lens.

With this configuration, the light from the second light source, which is disposed closer to the optical member than the first light source, can be diffused to a wider angle by the second lens than by the first lens. With this configuration, it is possible to prevent that the light irradiated from the second light source, which is disposed closer to the optical member than the first light source, is concentrated on a part of the display panel without being diffused. Thus, it is possible to prevent that uneven luminance occurs on a screen of the display panel due to the excessively high luminance at a part of the display panel directly above the second light source.

(5) In accordance with a preferred embodiment according to any one of the display devices mentioned above, the rear frame further has a step section between the first rear section and the second rear section.

With this configuration, the flat area of a surface connecting the second rear section and the first rear section as viewed in the front-rear direction can be reduced when the step section forms a perpendicular connection between the first rear section and the second rear section, compared to when the step section is formed by a gently sloping surface and forms a diagonal connection between the first rear section and the second rear section. With this configuration, the second rear section that provides a space for arranging component parts on the rear side thereof can be made larger.

(6) In accordance with a preferred embodiment according to any one of the display devices mentioned above, the display device further comprises a component part disposed on a rear side of the second rear section of the rear frame.

(7) In accordance with a preferred embodiment according to any one of the display devices mentioned above, the component part is disposed within a space defined between the first rear section and the second rear section in the front-rear direction.

(8) In accordance with a preferred embodiment according to any one of the display devices mentioned above, the display device further comprises a rear cover covering the component part from the rear side of the display device.

(9) In accordance with a preferred embodiment according to any one of the display devices mentioned above, the rear cover is attached to the rear frame.

With this configuration, the component part can be disposed on the rear side of the second rear section that is located forward relative to the first rear section in the rear frame. Thus, it is possible to prevent the space for arranging the component part from protruding significantly to the rear side. In addition, the rear cover covers the component part disposed on the rear side of the second rear section that is a part of the rear frame. Thus, there is no need to cover the entire rear frame with the rear cover. With this configuration, it is possible to prevent the rear cover from becoming larger.

(10) In accordance with a preferred embodiment according to any one of the display devices mentioned above, the component part includes at least one of a power supply board that is configured to supply power to the display panel and the backlight unit, a control board that is configured to control the display panel and the backlight unit, and a speaker.

With this configuration, at least one of the power supply board, the control board and the speaker can be disposed in the space on the rear side of the second rear section. In addition, these component parts are not disposed on the periphery of the display panel. Thus, it is possible to prevent the frame around the periphery of the display panel (the so-called picture frame) from becoming larger.

(11) In accordance with a preferred embodiment according to any one of the display devices mentioned above, the rear cover is attached to the rear frame such that a rear surface of the rear cover is flush with a rear surface of the first rear section of the rear frame.

With this configuration, the position of the rear side of the display device can be aligned with the position of the rear surface of the first rear section of the rear frame. Thus, it is possible to effectively prevent the increase in the thickness of the display device in the front-rear direction. In addition, it is possible to prevent the formation of a protruding portion on the rear side of the display device. Thus, there is no need to increase the size of the packing material used to pack the display device to match the size of the protruding portion. With this configuration, it is possible to effectively prevent the increase in the size of the packing material in the front-rear direction.

(12) In accordance with a preferred embodiment according to any one of the display devices mentioned above, the first light source portion and the second light source portion each include a plurality of light emitting elements that is configured to emit light and a light source board on which the light emitting elements are arranged.

(13) In accordance with a preferred embodiment according to any one of the display devices mentioned above, the backlight unit includes a reflective sheet that is configured to reflect light from the light source unit toward the display panel.

(14) In accordance with a preferred embodiment according to any one of the display devices mentioned above, at least one of the light source board of the second light source and a part of the reflective sheet that is disposed on the second rear section of the rear frame includes a light reflection suppressing portion to suppress reflection of light.

With this configuration, the light from the light source unit can be efficiently incident on the optical member by being reflected by the reflective sheet. In addition, it is possible to suppress the reflection of light from the second light source that is disposed closer to the optical member than the first light source by the light reflection suppressing portion. Thus, it is possible to effectively prevent the light from the second light source that is disposed closer to the optical member than the first light source from being concentrated in a portion without diffusion. As a result, it is possible to effectively prevent uneven luminance from occurring on the screen of the display panel due to excessively high luminance of a part of the display panel directly above the second light source.

(15) In accordance with a preferred embodiment according to any one of the display devices mentioned above, the second rear section of the rear frame is disposed at a lower portion of the rear frame in an up-down direction of the display device.

(16) In accordance with a preferred embodiment according to any one of the display devices mentioned above, the second rear section of the rear frame is disposed at at least one of both end portions in a left-right direction of the display device.

With this configuration, the second rear section can be disposed at an end portion of the rear frame in the up-down direction and in the left-right direction. Thus, it is possible to provide a space for arranging necessary component parts at an end portion of the rear frame in the up-down direction and in the left-right direction on the rear side of the rear frame.

(17) In accordance with a preferred embodiment according to any one of the display devices mentioned above, the backlight unit includes a columnar spacer member to maintain a uniform distance between the light source unit and the optical member.

(18) In accordance with a preferred embodiment according to any one of the display devices mentioned above, the columnar spacer member includes a first columnar spacer member that is disposed on the first rear section of the rear frame and a second columnar spacer member that is disposed on the second rear section of the rear frame, and the first columnar spacer member is longer in the front-rear direction than the second columnar spacer member.

With this configuration, the first columnar spacer member can maintain a uniform distance between the first light source that is disposed on the first rear section and the optical member, and the second columnar spacer member can maintain a uniform distance between the second light source that is disposed on the second rear section and the optical member. As a result, the state of irradiation of light from the light source unit can be maintained. Thus, it is possible to prevent uneven luminance from occurring due to the change in the state of light irradiated to the display panel.

(19) In accordance with a preferred embodiment according to any one of the display devices mentioned above, the step section forms a diagonal connection between the first rear section and the second rear section.

(20) In accordance with a preferred embodiment according to any one of the display devices mentioned above, the step section forms a perpendicular connection between the first rear section and the second rear section.

According to the present disclosure, it is possible to provide a display device that can prevent the increase in thickness in the front-rear direction.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a display device in an upright position on a horizontal surface. Accordingly, these directional terms, as utilized to describe the display device should be interpreted relative to a display device on a horizontal surface. The terms “left” and “right” are used to indicate the “right” when referencing from the right side as viewed from the rear side of the display device, and the “left” when referencing from the left side as viewed from the rear side of the display device.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A display device comprising:
a display panel with a display surface;
a backlight unit configured to irradiate light to the display panel from a rear side of the display panel, the backlight unit including a light source unit that is configured to emit light and a sheet-like optical member that is configured to diffuse the light from the light source unit toward a rear surface of the display panel; and
a rear frame covering the backlight unit from a rear side of the display device,
the light source unit having
a first light source that is disposed spaced apart from the optical member in a front-rear direction of the display device and is provided with a first lens, and
a second light source that is disposed spaced apart from the optical member and closer to the optical member than the first light source in the front-rear direction and is provided with a second lens, the first lens and the second lens having different light distribution characteristics from each other.

2. The display device according to claim 1, wherein
the rear frame has
a first rear section on which the first light source is disposed, and
a second rear section on which the second light source is disposed, the second rear section being disposed closer to the optical member than the first rear section.

3. The display device according to claim 1, wherein
the rear frame is provided to face the optical member.

4. The display device according to claim 1, wherein
the second lens is configured to diffuse light more than the first lens.

5. The display device according to claim 2, wherein
the rear frame further has a step section between the first rear section and the second rear section.

6. The display device according to claim 2, further comprising
a component part disposed on a rear side of the second rear section of the rear frame.

7. The display device according to claim 6, wherein
the component part is disposed within a space defined between the first rear section and the second rear section in the front-rear direction.

8. The display device according to claim 6, further comprising
a rear cover covering the component part from the rear side of the display device.

9. The display device according to claim 8, wherein
the rear cover is attached to the rear frame.

10. The display device according to claim 6, wherein
the component part includes at least one of a power supply board that is configured to supply power to the display panel and the backlight unit, a control board that is configured to control the display panel and the backlight unit, and a speaker.

11. The display device according to claim 6, wherein
the rear cover is attached to the rear frame such that a rear surface of the rear cover is flush with a rear surface of the first rear section of the rear frame.

12. The display device according to claim 1, wherein
the first light source and the second light source each include a plurality of light emitting elements that is configured to emit light and a light source board on which the light emitting elements are arranged.

13. The display device according to claim 12, wherein
the backlight unit includes a reflective sheet that is configured to reflect light from the light source unit toward the display panel.

14. The display device according to claim 13, wherein
at least one of the light source board of the second light source and a part of the reflective sheet that is disposed on the second rear section of the rear frame includes a light reflection suppressing portion to suppress reflection of light.

15. The display device according to claim 1, wherein
the second rear section of the rear frame is disposed at a lower portion of the rear frame in an up-down direction of the display device.

16. The display device according to claim 15, wherein
the second rear section of the rear frame is disposed at at least one of both end portions of the rear frame in a left-right direction of the display device.

17. The display device according to claim 1, wherein
the backlight unit includes a columnar spacer member to maintain a uniform distance between the light source unit and the optical member.

18. The display device according to claim 17, wherein
the columnar spacer member includes a first columnar spacer member that is disposed on the first rear section of the rear frame and a second columnar spacer member that is disposed on the second rear section of the rear frame, and
the first columnar spacer member is longer in the front-rear direction of the display device than the second columnar spacer member.

19. The display device according to claim 5, wherein
the step section forms a diagonal connection between the first rear section and the second rear section.

20. The display device according to claim 5, wherein
the step section forms a perpendicular connection between the first rear section and the second rear section.
